(19) United States
(12) Patent Application Publication
(10) Pub. No.: US 2018/0220669 A1
(43) Pub. Date: Aug. 9, 2018

(54) System and Method for Producing a Cheese Product With or Without Inclusions

(71) Applicant: WhiteWave Services, Inc., Denver, CO (US)

(72) Inventors: Ming Hwei Lau, Broomfield, CO (US); Petros Aristotelis Levis, Denver, CO (US)

(21) Appl. No.: 15/428,326

(22) Filed: Feb. 9, 2017

(51) Int. Cl. A23C 19/09

(52) U.S. Cl. CPC A23C 19/0912; A23C 19/0921; A23C 19/0925

(57) ABSTRACT

An apparatus for producing a cheese product includes a grinder operable to receive raw cheese and grind the cheese into granules having less than 0.25 inches in length. The apparatus further includes a dispenser operable to dispense the granulated cheese into one or more molds. The apparatus further includes a dryer comprising a microwave element. The dryer is operable to heat and remove moisture from the granulated cheese using at least microwave radiation in a heating zone. The apparatus further includes a cooling tunnel operable to cool and remove moisture from the dried cheese.

### TECHNICAL FIELD OF THE DISCLOSURE

This invention relates in general to a system and method of producing a food product and more particularly to producing a dried cheese food product with or without inclusions.

### BACKGROUND

Dried cheese crisp food products are healthy snacks that have a long, ambient shelf life and a satisfying taste and texture. The production of dried cheese crisps often require special raw cheese formulations that use a non-melting cheese and/or introduce cellulose, polysaccharides, coatings, or other ingredients to prevent sticking, oiling off, or uneven drying. The special raw cheese formulations may require specific ranges of pH, fat levels, and moisture levels in order to produce the dried cheese crisps.

In addition, the production of dried cheese crisps often includes complicated processes, including using complex cheese formulations and/or multiple drying and cooling stages. Conventional microwave vacuum ovens using a tumble system used in drying cheese products limit the shapes and sizes of the final dried cheese products and can be uneconomical. Conventional ovens or dehydrators require two or more hours to dry the cheese in order to create the cheese crisp. This long process may cause excessive oiling off and uneven drying, producing a case-hardening on the surface with a soft center in the cheese crisp, limiting shelf life and quality. Freeze dried processes may be used for producing cheese crisps, but the process may require in excess of 8 hours and is cannot be implemented in an economical way.

### SUMMARY

Particular embodiments described herein include an apparatus for producing a cheese product. According to some embodiments, an apparatus for producing a cheese product comprises a grinder operable to receive raw cheese and grind the cheese into granules having less than 0.25 inches in length. The apparatus comprises a dispenser operable to dispense the granulated cheese into one or more receptacles. The apparatus further comprises a dryer comprising a microwave element. The dryer is operable to heat and remove moisture from the granulated cheese using at least microwave radiation in a heating zone. The apparatus further comprises a cooling tunnel operable to cool and remove moisture from the dried cheese.

In particular embodiments, the microwave element emits radiation at a frequency in the range of 850 to 950 MHz in the heating zone.

In particular embodiments, the dryer further comprises an oven element operable to expose the granulated cheese to heated air in the heating zone.

In particular embodiments, the apparatus further comprises a mixer operable to mix one or more non-cheese ingredients into the granulated raw cheese before it enters the dryer. In some embodiments, at least one of the non-cheese ingredients comprises a vegetable, a fruit, a flavor, a spice, an herb, a nut, a vitamin, a mineral, or a functional nutrient.

In particular embodiments, the cheese product has a final moisture content of 2.5% or less.

In particular embodiments, the dryer comprises a ventilator system operable to provide a relative humidity below 50% in the heating zone.

In particular embodiments, the cooling tunnel comprises a forming element capable of forming the dried cheese into a three dimensional shape.

In particular embodiments, the raw cheese comprises one or more cheese selected from the group comprising Cheddar cheese, Monterey Jack cheese, Gouda cheese, and/or Parmesan cheese.

Particular embodiments described herein include a method for producing a cheese product. According to some embodiments, a method for producing a dried cheese crisp comprises grinding raw cheese into granules. Each granule of raw cheese has a length less than 0.25 inches. The method further comprises dispensing a portion of the granulated raw cheese into one or more receptacles. The method further comprises drying the granulated raw cheese comprising exposing the granulated raw cheese to microwave radiation in a heating zone. The method further comprises cooling the dried cheese in a cooling tunnel to create the dried cheese crisp.

In particular embodiments, the method further comprises mixing one or more non-cheese ingredients into the granulated raw cheese prior to drying. In some embodiments at least one of the non-cheese ingredients comprises a vegetable, a fruit, a flavor, a spice, an herb, a nut, a vitamin, a mineral, or a functional nutrient.

In particular embodiments, the microwave radiation in the heating zone is radiation having a frequency in the range of 850 to 950 MHz.

In particular embodiments, the power of the microwave radiation in the heating zone is modulated depending on the composition and volume of the dispensed granulated cheese.

In particular embodiments, drying further comprises exposing the granulated raw cheese to hot air with temperature of at least 350 degrees Fahrenheit.

In particular embodiments, cooling comprises removing the dried cheese from the one or more receptacles. Cooling further comprises forming the dried cheese into a three-dimensional shape by bending, folding, or molding the dried cheese.

In particular embodiments, the method further comprises continuously unloading the dried cheese crisp from the cooling tunnel onto a conveyor belt.

In particular embodiments, drying further comprises providing a relative humidity of less than 50% in the heating zone.

In particular embodiments, the heating zone comprises a first subzone exposing the granulated raw cheese to a first power level of microwave radiation. The heating zone further comprises a second subzone exposing the granulated raw cheese to a second power level of microwave radiation. The first power level of microwave radiation is higher than the second power level of microwave radiation.

According to some embodiments, a method for producing dried cheese crisps, comprises providing raw cheese. The method further comprises cutting the raw cheese into smaller pieces of raw cheese. The method further comprises grinding the smaller pieces of raw cheese into granules. Each granule of raw cheese has a length less than 0.25 inches. The method further comprises dispensing a quantity of granulated cheese into one or more receptacles. The method further comprises drying the dispensed granulated cheese in a microwave cavity. The method further comprises removing excess moisture from the microwave cavity to provide a relative humidity of less than 50%. The method further comprises cooling the dried cheese comprising removing surface moisture to produce the dried cheese crisp.

Certain embodiments of the present disclosure may provide one or more technical advantages. As an example, embodiments described herein, may allow the use of any raw cheese, such as a melting cheese (e.g., Gouda, Cheddar, Swiss, Provolone, Mozzarella, Gruyere, Colby, Monterey Jack, etc.), to produce a dried cheese crisp. The raw cheese introduced to the system need not be of a particular type or have a particular formulation. Nor does the raw cheese require a special treatment, such as the application of a particular coating, before being processed to produce the dried cheese crisp.

Another technical advantage of the system and method of producing a cheese product is that in certain embodiments, the drying of the cheese requires a single drying process carried out over a short period of time. Conventional methods and systems involve a lengthy drying process requiring multiple drying steps and iterations to produce the final product. In particular embodiments, the grinding of the raw cheese into small granules and the drying using at least microwave radiation provides a simple and quick process of producing a dried cheese crisp.

In addition, certain embodiments present the advantage of providing a versatile system to produce a variety of different dried cheese crisp products. In some embodiments, the dryer may comprise different heating elements. The combination of different heating elements may improve taste, texture, uniformity, or other quality. In addition, some embodiments allow the cheese to be dried in various sizes, shapes, and thicknesses by dispensing the granulated cheese into different receptacles and in different volumes. As discussed above, in some embodiments, any raw cheese may be used to produce the dried cheese crisp. The system and method in particular embodiments allow for different dispensing, drying, and cooling settings and modulation thereof to provide the optimal production of the dried cheese crisp based on the type of cheese introduced, among other factors.

Another technical advantage in particular embodiments of the system and method is the ability to produce a dried cheese crisp product with or without certain inclusions. In some embodiments, non-cheese ingredients may be introduced to the granulated cheese before drying. Different included ingredients may change the flavor, texture, nutritional profile, or other characteristics of the final dried cheese crisp. For example, the producer may mix particular vegetables, fruits, flavors, spices, herbs, nuts, vitamins, minerals, or functional nutrients into the granulated cheese in order to produce a dried cheese crisp having those introduced flavors, nutrients, and textures which complement the cheese.

Other technical advantages of the present disclosure will be readily apparent to one skilled in the art from the following figures, descriptions, and claims. Moreover, while specific advantages have been enumerated above, various embodiments can include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example system for producing a dried cheese product, according to some embodiments;

FIG. 2 illustrates an example method for producing dried cheese product, according to some embodiments; and

FIGS. 3A-3E illustrate an example dried cheese product at various stages of production, according to some embodiments.

### DETAILED DESCRIPTION

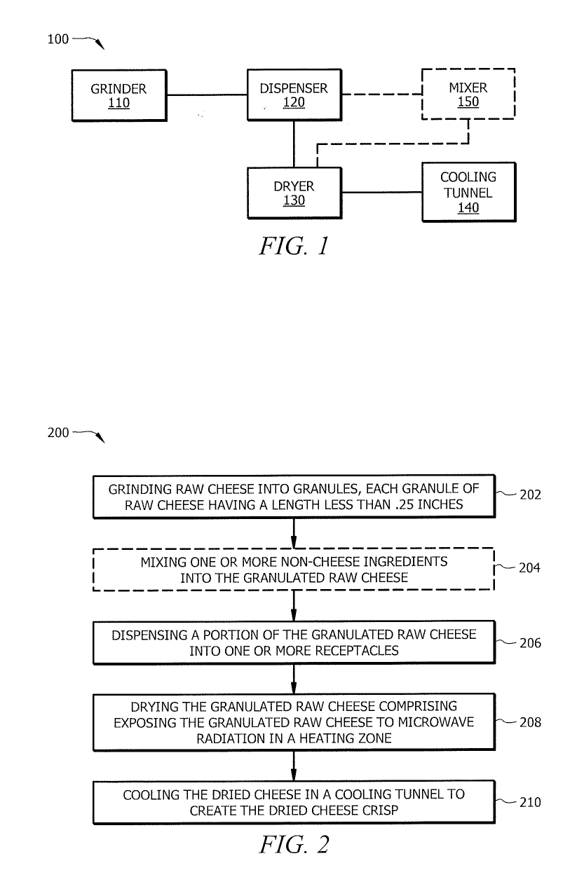

Embodiments of the present invention and its advantages are best understood by referring to FIGS. 1, 2, and 3A-3E of the drawings, like numerals being used for like and corresponding parts of the various drawings.

FIG. 1 illustrates an example of a system 100 for producing a dried cheese product, according to some embodiments. System 100 may comprise at least one of each of a grinder 110, a dispenser 120, a dryer 130, and a cooler 140. In particular embodiments, the system may further comprise a mixer 150.

In operation, an operator of system 100 may select an appropriate raw cheese or a mixture of raw cheeses for the desired final dried cheese crisp. For example, the operator may select a cheddar cheese as the raw cheese to be introduced. In other examples, the operator may select one or more of a Swiss, Gouda, Monterey Jack, Parmesan cheese, among others, for the dried cheese crisp. The system 100 may produce a dried cheese crisp using any type of cheese, including cheeses not listed above. For example, the raw cheese used may be full fat, reduced fact, or low fat. The raw cheese may be a semi-soft cheese, a medium hard cheese, or a hard cheese. The raw cheese may be non-melting or a melting cheese.

The raw cheese may be processed by grinder 110. The operator may introduce the raw cheese in to grinder 110 using any suitable means. In some embodiments, the operator may introduce one type of raw cheese into system 100 which is grinded by grinder 110. In other embodiments, the operator may introduce multiple raw cheeses into system 100 and grinder 110. In such embodiments, each cheese may be introduced to grinder 110 separately, or alternatively, introduced into the grinder contemporaneously.

In some embodiments, the raw cheese may be introduced into the grinder without any additional ingredients or inclusions. For example, the raw cheese may be free from ingredients such as cellulose, polysaccharides or other coatings. In this way, system 100 may produce a dried cheese crisp using only natural ingredients. Thus, in certain embodiments, the raw cheese need not be specially formulated for producing a dried cheese crisp product. For example, in certain embodiments, natural or organic cheese can be used. Although certain embodiments of the present disclosure refer to a natural or organic cheese, a dried cheese crisp may be produced using certain methods and systems disclosed herein with cheese that is non-organic and/or processed. Furthermore, cheeses produced from non-dairy sources, may be used.

Grinder 110 may be operable to receive raw cheese. The raw cheese may be introduced directly to grinder 110 by the operator or the raw cheese may be first processed by another system or device before grinder 110 receives the raw cheese. For example, the raw cheese may be cut into smaller pieces before grinder 110 receives it.

Grinder 110 may comprise any suitable grinding implements to grind the received raw cheese. For example, an operator may grind the cheese using an industrial grinder. Grinder 110 may be operated manually or automatically and may be powered by electricity, hydraulic pressure, and/or air pressure. Grinder 110 may include one or more motors, blades, hoppers, feeding worms, and/or drain lines. In other embodiments, the cheese may be ground by a food processor. In some examples, the cheese may be ground by a hand-held utensil.

Grinder 110 may grind the cheese to a desired consistency or particle size. In some embodiments, grinder 110 is operable to grind the raw cheese into granules having a length of less than 0.25 inches. For example, grinder 110 may include an automatic dicer and/or shredder equipped with a shred head used to produce cheese granules having length less than 0.25 inches. In certain embodiments, the particle size may be determined based on an average or a mean particle size of a sample portion of the granules. By grinding the raw cheese into small granules, the cheese may be more effectively dried to create the dried cheese crisp. The small granule size of the raw cheese may also allow the inclusion of non-cheese ingredients before drying to produce different types of cheese crisp products. The granule size of the ground cheese may or may not be uniform.

Grinder 110 may be connected to other components which enable the grinder to receive the raw cheese and/or move the granulated cheese to other components. For example, a standard steel conveyer belt with a hopper may transport the cheese between one or more components of system 100. In some embodiments, grinder 110 is directly connected with another component, such as the dispenser 120. In other embodiments, grinder 110 is indirectly connected with other components. For example, grinder 110 may be indirectly connected to dispenser 120 through mixer 150 which receives the granulated cheese and allows the mixture of non-cheese ingredients before reaching dispenser 120.

After the raw cheese is granulated by grinder 110, it may be introduced to dispenser 120. The granulated raw cheese may be introduced directly from grinder 110 to dispenser 120, or alternatively, it may be introduced via another component. For example, grinder 110 may be a distance away from dispenser 120, requiring some conveyor or similar device to transport the granulated raw cheese. In another example, the granulated raw cheese may be first processed by another component, such as mixer 150, before being introduced to dispenser 120.

Dispenser 120 may be any suitable dispenser operable to dispense the granulated raw cheese, including any non-cheese ingredients which may have been introduced via the optional mixer 150. In some embodiments, dispenser 120 may dispense the granulated raw cheese into one or more receptacles capable of holding a quantity of granulated cheese.

In particular embodiments, the one or more receptacles have a predetermined size and shape corresponding to the desired size and shape of the final dried cheese crisp. For example, each receptacle may comprise a mold having a one of a variety of shapes. For example the mold may be one of a cracker-shape mold, a donut-shape mold with an indentation in the center, a bar shape mold, a rectangular mold, a cylindrical mold, a circular mold, a square mold, a flower-shaped mold, or an animal-shaped mold (e.g. a cow-shaped mold). In other embodiments, the size and shape of the receptacle may not correspond to the size and shape of the final dried cheese crisp. As an example, the receptacle may comprise a tray or simply a conveyer belt.

The receptacle may comprise of material durable against the drying process. In some embodiments, the receptacle may comprise a silicon mold having the desired shape of the final dried cheese crisp. A silicon mold may also be desirable because of it may prevent the dried cheese crisp from sticking to the mold after being dried. A person having skill in the art would recognize that dispenser 120 may dispense the granulated cheese into any suitable receptacle before it is introduced to dryer 130.

In some embodiments, dispenser 120 may automatically and continuously dispense a predetermined portion of the granulated raw cheese into the one or more receptacles. The amount of granulated cheese dispensed may be determined based on a number of factors, including, but not limited to, the type of cheese to be dispensed, the receiving receptacle shape and size, or the desired size, thickness, or shape of the final dried cheese crisp. Dispenser 120 operating automatically and continuously may allow the production of a substantially uniform final dried cheese product at a high rate of production.

After being dispensed by dispenser 120, the granulated cheese (and any non-cheese ingredients) may be introduced to dryer 130. In some embodiments, dryer 130 is operable to heat and remove moisture from the granulated cheese using at least microwave radiation in a heating zone. When the granulated cheese is introduced to dryer 130, it may enter at least one heating zone. In some embodiments, the heating zone comprises a microwave cavity wherein the granulated cheese is subject to microwave radiation in order to heat and dry the granulated cheese. In the heating zone, the granulated cheese may be superheated producing a puffing effect, which may produce a certain texture and density in the final dried cheese crisp.

Dryer 130 may comprise a microwave element which enables the dryer to heat and dry the granulated cheese introduced to dryer 130. For example, the microwave element may be a microwave oven which emits microwave radiation into the heating zone of dryer 130. The use of microwave radiation provides a quick way to introduce heat to and remove moisture from the granulated cheese.

In some embodiments, the microwave element may emit radiation at a frequency range of 850 to 950 MHz. For example, the microwave element may be a commercial grade 915 MHz microwave oven. The frequency range around 915 MHz more deeply penetrates moisture rich food products, such as cheese. For example, compared to the typical home-use 2.45 GHz microwave ovens, the penetration depth of 915 MHz frequencies may be nearly 3 times that of the 2.45 GHz frequencies. In addition, commercial grade 915 MHz microwave ovens may be more efficient and able to produce a greater power output compared to home-use ovens.

Dryer 130 may be adjusted in order to provide the optimal amount of drying to the granulated cheese. In some embodiments, dryer 130 may be adjusted by adjusting the duration and power of the microwave element's radiation in the heating zone exposed to the granulated cheese present. Adjusting dryer 130 may be dependent on the composition and volume of granulated cheese introduced to dryer 130. For example, a high fat cheese may require higher intensity of microwave radiation during a first period and then a lower intensity of microwave radiation afterwards for a second period. The adjustments may be predetermined drying settings for dryer 130 depending on the dispensed granulated cheese and desired properties of the final dried cheese crisp.

In particular embodiments, dryer 130 may further comprise an oven element operable to expose the granulated cheese to heated air in the heating zone. For example, dryer 130 may comprise a conventional oven (or a convection oven) which produces heated air of at least 350 degrees which enters at least a portion of the heating zone of dryer 130. In another example, dryer 130 comprises a microwave-assisted oven which comprises the oven element and the microwave element. The oven element and microwave element may work separately or in tandem to dry the granulated cheese in the heating zone. As with the microwave element, the oven element may be adjustable to provide a determined temperature and convection level at a portion of the heating zone to optimally dry the granulated cheese.

The use of heated air from the oven element in particular embodiments may provide several advantages. First, the heated air may insulate the heated granulated cheese preventing rapid cooling. The granulated cheese may be heated to a temperature which is greater than the ambient temperature of the environment of system 100, for example, by the microwave radiation in the heating zone. If the microwave radiation ceases, the surrounding air may cool the heated cheese even if the cheese is still in the heating zone of dryer 130. This may produce undesired effects in the production of the dried cheese crisp or produce undesired properties or characteristics of the final dried cheese crisp. The addition of the oven element, as described in particular embodiments, may prevent the undesired premature cooling and hardening.

Second, the heated air in conjunction with the microwave radiation may provide a more uniform heating of the granulated cheese. In some cases, the microwave radiation may not be uniformly exposed to the granulated cheese within the heating zone. For example, the surface of the granulated cheese may not be heated and dried by the microwave radiation at the same rate as the interior portions of the granulated cheese. Thus, as described in certain embodiments, the addition of an oven element may provide for more uniform heating producing a more uniformly dried cheese crisp.

In particular embodiments, the heating zone of dryer 130 may have multiple stages or subzones. The subzones of the heating zone may have different heating and drying properties. For example, in a first subzone the granulated raw cheese may be exposed to a first power level of microwave radiation and in a second subzone it may be exposed to a second power level of microwave radiation different than the first power level. Because any type of cheese may be introduced to system 100, dryer 130 may be operable to have multiple subzones which are adjustable based on, at least, the composition of cheese introduced.

Subzones may also use different types of drying elements and/or in different combinations. As an example, a first subzone may apply microwave radiation at full power as well as oven-heated air at 350 degrees Fahrenheit. The second subzone may then apply microwave radiation at a reduced power, e.g. at a 50% power level, in addition to the oven heated air. There may also be a third subzone where only the heated air is provided and no microwave radiation is emitted. Different combinations of heating and drying elements in dryer 130 may be contemplated by persons having ordinary skill in the art in order to produce desirable cheese crisps based on, at least, the composition and volume of cheese introduced.

In some embodiments, dryer 130 may also comprise a ventilator system operable to provide a relative humidity of 50% or lower inside the heating zone in the dryer 130. The ventilator system may operate by removing humid air from the dryer 130 and replacing it with less humid air. By providing a an environment having a relative humidity of 50% or lower, the dryer 130 may optimally dry the introduced granulated cheese. For example, a high relative humidity may reduce the driving force to drive moisture from the center of the cheese to its surface, which may cause the granulated cheese to retain too much moisture to produce the desired cheese dried crisp. In addition, a high humidity may damage the system 100 or cause the microwave element to spark or arc, which may create a dangerous condition for persons near the system 100. A person having skill in the art would appreciate there are a number of ways to implement a ventilator system into the dryer 130 either as a separate component or integrated into an element present in the dryer 130.

After passing through dryer 130, the now dried cheese may enter cooling tunnel 140. The cooling tunnel may cool the dried cheese and continue to remove moisture from the dried cheese. In some embodiments, the cooling tunnel 140 may have a lower temperature environment than the dryer 130 in order to cool the dried cheese. In particular embodiments, the cooling tunnel 140 may have a lower humidity than the dryer 130. As an example, the cooling tunnel 140 may be an at least partially enclosed tunnel having a conveyer moving the dried cheese from the dryer 130 towards a packaging area. In this particular example, the cooler air in the tunnel cools the dried cheese and the moving air over the dried cheese moving on the conveyor helping to remove additional moisture.

In some embodiments, the cooling tunnel 140 may comprise a ventilator system to reduce the humidity in the cooling tunnel 140. The reduced humidity may enhance the cooling and drying of the cheese. A person having ordinary skill in the art would recognize there may be a number of ways to implement a ventilating system in order to control the environment in the cooling tunnel 140.

In some embodiments, the cheese entering the cooling tunnel 140 from the dryer and/or while the cheese is in the cooling tunnel 140 may be in a lava state. The lava state of the cheese is characterized by high temperature, but a low moisture content relative to the moisture content before being introduced to the dryer 130. In this state, the cheese is malleable and may be formed into a variety of shapes. In some embodiments, the lava state cheese is maintained in the receptacle after the dryer 130 and during its time in the cooling tunnel 140 and only removed once in a final dried cheese crisp state. If allowed to cool and continue to dry in the mold, the cheese may take on the form of the mold. For example, if the cheese is maintained in a square mold in the lava state in the cooling tunnel 140, then the cheese may take a square shape and form a dried cheese crisp having a square shape.

In particular embodiments, cooling tunnel 140 may comprise a forming element capable of forming the dried cheese into a three dimensional shape. The three dimensional shape may be any shape suitable for packaging and eating by the end consumer. For example, the three dimensional shape may be one of a bowl shape, a saddle shape, or a shape having one or more ridges. In particular embodiments, the forming element may be a non-stick and semi-rigid implement employed to form the dried cheese into a variety of three dimensional shapes.

Of particular importance is the timing when the cheese is introduced to the forming element after being heated and dried by the dryer 130. When the cheese is in the lava state, the cheese may be malleable enough to create the three dimensional shape, but also solid enough to allow handling of the cheese in order to use the forming element. If the cheese has too high of a moisture level, it may be unwieldy to handle, resulting in malformed cheese crisps or other unintended consequences. If the cheese has cooled too much before being introduced to the forming element, the forming element may not be able to form the dried cheese into the desired shape. The particular positions of the forming element and timing to introduce the lava state cheese may be predetermined based on the cheese introduced and the applied drying and heating by the dryer 130.

As an example, a forming element may comprise a bowl shaped implement, wherein the lava state cheese is disposed over the bowl shaped implement after being removed from its receptacle. In this example, the lava state cheese continues to cool and dry over the bowl shaped implement, taking on that bowl shape. Once the cheese forms into the final dried cheese crisp state, the cheese crisp, now having a three dimensional bowl shape may be removed and then subsequently packaged. This is merely intended as an example to illustrate particular embodiments. One having ordinary skill in the art would recognize that a variety of different forming elements may be used to create a three dimensional shape while the cheese is in the lava state.

The finished dried cheese crisp product may be removed from the cooling tunnel 140. In some embodiments, the final moisture a moisture content of cheese product is 2.5% or less. The low moisture content may provide a particular mouthfeel and crunchiness. Additionally, a lower moisture content during packaging of the finished dried cheese crisp may aid in extending shelf life and maintaining the optimal state of the dried cheese crisp for the end user.

In particular embodiments including the mixer 150, after grinding in the grinder 110, the granulated cheese may be introduced into the mixer 150. The mixer 150 may allow the introduction of non-cheese ingredients into the granulated cheese before drying and cooling to form the dried cheese crisp. Non-cheese ingredients that may be introduced may comprise a vegetable, a fruit, a flavor, a spice, an herb, a nut, a vitamin, a mineral, or a functional nutrient.

In some embodiments, the mixer 150 may introduce one or more of the non-cheese ingredients into the granulated cheese. The mixer may then mix the one or more non-cheese ingredients into the granulated cheese before it enters into the dryer 130. The mixer 150 may ensure that the non-cheese ingredients are suitably mixed with the granulated cheese so that they are uniformly distributed. Proper mixing may enhance the uniformity of the drying process and provide a consistent dried cheese crisp product.

After the mixer 150 mixes the granulated cheese and the non-cheese ingredient(s), the mixture may be introduced to the dispenser 120 and processed as discussed previously in reference to the other elements comprising system 100. In particular, adjustments to parameters or settings of one or more of the grinder 110, dispenser 120, dryer 130, and cooling tunnel 140 may be made based on the inclusion of any non-cheese ingredients.

Modifications, additions, or omissions can be made to system 100 without departing from the scope of the invention. The components of system 100 can be integrated or separated. Moreover, the operations of system 100 can be performed by more, fewer, or other components.

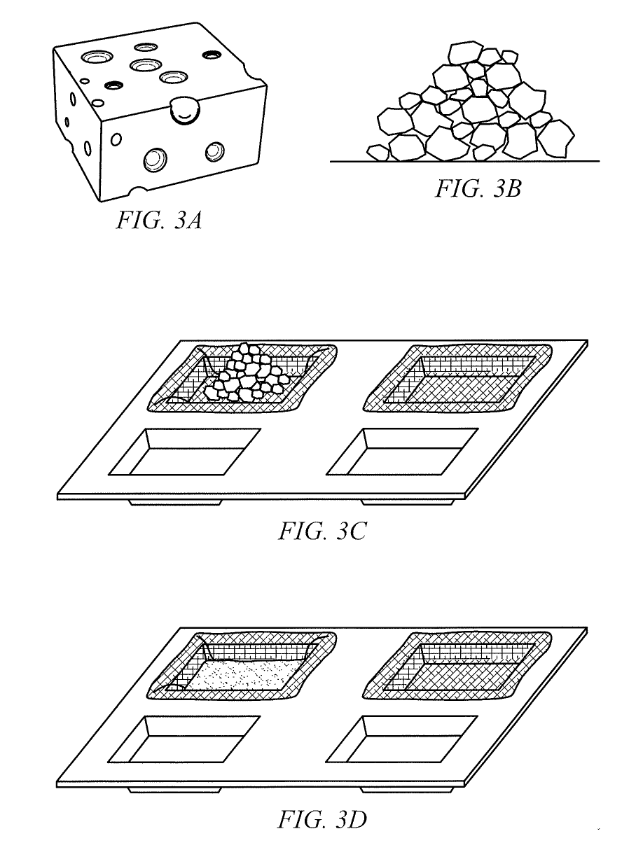

FIG. 2 illustrates an example of a method for producing dried cheese product, according to some embodiments. The illustrated method 200 begins with step 202 comprising grinding raw cheese into granules, each granule of raw cheese having a length less than 0.25 inches. Step 202 may be carried out by a suitable grinder, such as grinder 120 discussed above in reference to FIG. 1. An operator may introduce raw cheese directly or indirectly into a grinding device in order to carry out step 202 in producing granulated cheese.

In particular embodiments, the operator may first provide the raw cheese and cut the raw cheese into smaller pieces of raw cheese. For example, an operator may buy raw cheese in bulk which may come in large blocks. The operator may provide the large block of raw cheese and then cause it to be cut into smaller pieces before introducing the raw cheese into a grinder. By cutting the cheese into smaller pieces, the operator facilitate the grinding of the cheese into granules. In certain embodiments, an operator may provide the raw cheese such that it does not need to be processed or reduced in size before grinding.

After the cheese is grinded into granules, the method moves to step 204. At step 204, a portion of the granulated raw cheese is dispensed into one or more receptacles. As discussed above in reference to dispenser 120 of FIG. 1, in some embodiments, the granulated cheese may be dispensed automatically and continuously in order to provide a consistent product at a high rate of production.

After the cheese is dispensed into a receptacle, the method moves to step 206. Step 206 comprises drying the granulated cheese comprising exposing the granulated raw cheese to microwave radiation in a heating zone. Microwave radiation may cause the granulated cheese to be superheated, causing a puffing effect. In some embodiments, the granulated raw cheese is exposed to microwave radiation have a frequency in the range of 850 to 950 MHz. For example, the microwave radiation may be emitted by a commercial microwave oven of 915 MHz in a microwave cavity in which the granulated cheese is present.

In some embodiments, the power of the microwave radiation in the heating zone is modulated depending on the composition and volume of the dispensed granulated cheese. As discussed in reference to FIG. 1, different cheeses may require different drying parameters. In some embodiments, the microwave radiation is modulated based on predetermined parameters based on at least one of the type of cheese(s) chosen and the volume of cheese introduced to create each dried cheese crisp. In particular embodiments providing non-cheese ingredient(s) into the granulated cheese, the modulation may depend on the composition and volume of the non-cheese ingredient(s).

In some embodiments, step 206 further comprises providing a relative humidity of less than 50% in the heating zone. A particular relative humidity may be provided by active and/or passive means. For example, the environment where the drying occurs may be acted on by a ventilation system which removes humid air and replaces it with air having less moisture. A person having ordinary skill in the art would recognize there may be a variety of ways to implement humidity control during the drying of the cheese.

In some embodiments, step 206 comprises exposing the granulated raw cheese to hot air having a temperature of at least 350 degrees Fahrenheit. For example, a conventional oven may produce heated air which is exposed to the cheese during the drying in step 206. In another example, a microwave-assisted oven may expose the cheese to heated air in step 206. The exposure to the heated air may occur simultaneously with the exposure to microwave radiation, or alternatively, at a time before or after the exposure to microwave radiation. The heated air exposure may provide certain advantages outlined above in reference to FIG. 1. The temperature of at least 350 degrees Fahrenheit may provide adequate insulation to prevent premature cooling or hardening and may aid in providing more uniform heating.

In particular embodiments, the heating zone in which the cheese is exposed to microwave radiation in step 206 may comprise a first subzone exposing the granulated raw cheese to a first power level of microwave radiation. The heating zone may further comprise a second subzone exposing the granulated raw cheese to a second power level of microwave radiation, wherein the first power level is higher than the second power level. For example, in a first subzone of a heating zone, the operator may cause there to be microwave radiation from microwave oven at 100% power level of the microwave oven. In a second subzone, the operator may only set the output of the microwave oven at 50%. Thus, the cheese may be exposed to different levels of microwave radiation in the heating zone. In this way, the cheese may be optimally dried, since different cheese compositions and volumes may require different drying parameters.

After the cheese is dried, the method moves to step 208. At step 208, the dried cheese is cooled in a cooling tunnel to create the final dried cheese crisp. In particular embodiments, the final moisture content of the cheese product is 2.5% or less. In some embodiments, the dried cheese is maintained in the one or more receptacles during the cooling step, resulting in the final dried cheese crisp having a shape substantially corresponding to the shape of the one or more receptacles. For example, the dried cheese may be dispensed in step 204 into a receptacle comprising a silicon mold having a square shape. After drying in step 206, the dried cheese may be retained within the square mold during cooling in step 208, which may cause the final dried cheese crisp to have a square shape.

In particular embodiments, the cooling in step 208 comprises removing the dried cheese from the one or more receptacles and forming the dried cheese into a three-dimensional shape by mechanically bending, folding, or molding the dried cheese. The removal of the dried cheese would occur while the cheese is in a lava state, as described above. As an example, after being dried, the cheese may be in a lava state, during which an operator may cause the cheese to be removed from its receptacle. After being removed from the receptacle, the cheese may be formed over a metal bowl-shaped implement and then left to cool for a period of time. After which, the cheese may have been formed into a dried cheese crisp having the three dimensional shape of a bowl.

The steps illustrated in FIG. 2 can be combined, modified, or deleted where appropriate, and additional steps can also be added to those shown. In particular embodiments, the method 200 may further comprise a step 210 before step 204. At step 210 one or more non-cheese ingredients may be mixed into the granulated raw cheese prior to drying. In some embodiments, at least one of the non-cheese ingredients mixed in step 210 comprises a vegetable, a fruit, a flavor, a spice, an herb, a nut, a vitamin, a mineral, or a functional nutrient. For example, step 210 may be mixing the granulated cheese with specific herbs and spices to create a dried cheese crisp with a particular flavor. Step 210 may allow for the non-cheese ingredient(s) to be mixed substantially uniformly into the granulated cheese in order to produce a consistent end product.

In particular embodiments, the method may include a further step after cooling in step 208 of continuously unloading the dried cheese crisp products from the cooling tunnel onto a conveyor belt. After reaching a suitable form and moisture content, the dried cheese crisps may be moved in order to package them. In order to package them, the dried cheese crisps may be removed from the cooling tunnel and moved towards a packaging area. Carrying out the removal in a continuous manner may allow for the production of the cheese crisps to occur continuously and at a high rate of production. The unloading of the cheese crisp products is preferably done without breaking the dried cheese crisp.

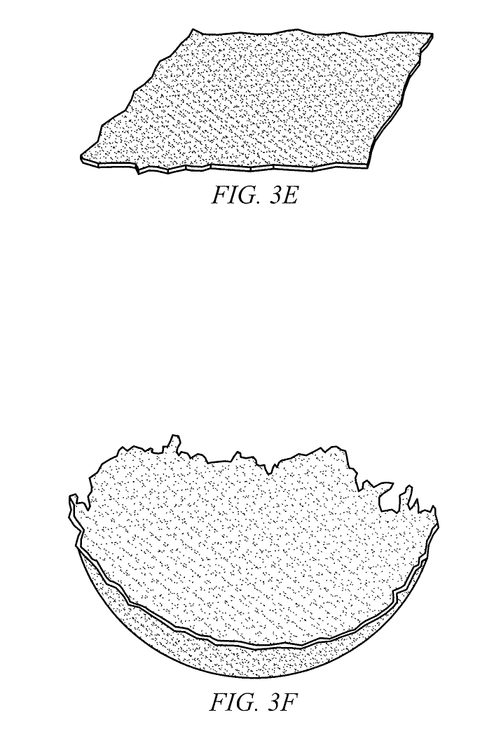

FIGS. 3A-3E illustrate an example dried cheese product at various stages of production, according to some embodiments. An operator may begin with raw cheese and produce a dried cheese crisp, according to certain embodiments. FIG. 3A illustrates an example raw cheese which may be used in producing the dried cheese crisp, according to some embodiments. The raw cheese may be provided in any suitable form for the production techniques and/or equipment used by the operator, according to some embodiments. For example, the raw cheese may be received by an operator in blocks, as illustrated in the example in FIG. 3A.

FIG. 3B illustrates an example portion of granulated raw cheese, according to some embodiments. The granulated cheese may be produced by grinding raw cheese larger portions of raw cheese. In some embodiments, the granules are less than 0.25 inches in length after grinding or being introduced into a grinder. The small size of the granules may enhance the drying and forming of the cheese in order to produce the dried cheese crisp.

FIG. 3C illustrates an example portion of granulated raw cheese dispensed in a receptacle, according to some embodiments. The amount and type of granulated raw cheese may vary according to various considerations regarding the final dried cheese crisp product. In the example illustrated, the portions of the granulated raw cheese may be dispensed in separate trays to produce multiple dried cheese crisps simultaneously.

FIG. 3D illustrates an example portion of dried cheese in the receptacle, according to some embodiments. After being heated and dried, the cheese may be in a lava state. As discussed previously, cheese in the lava state, as depicted in FIG. 3D, may be formed into different shapes. For example, an operator form the cheese into the shape of the receptacle by maintaining the cheese within the receptacle during its lava state during cooling. In another example, the operator cause the cheese to be removed during its lava state cheese from the receptacle and mechanically formed into a three dimensional shape different from the shape of the receptacle.

FIG. 3E illustrates two different example final dried cheese crisp products, according to some embodiments. In the left example illustrated in FIG. 3E, the dried cheese crisp is substantially two-dimensional, having been left in the receptacle during its lava state and cooling. In the right example illustrated in FIG. 3E, the dried cheese crisp has a three dimensional shape, having been mechanically formed while in its lava state and cooled to maintain that shape. Embodiments of systems and methods to produce dried cheese crisps described herein may produce dried cheese crisps of a variety of shapes and sizes beyond what is illustrated in FIG. 3E.

The FIGS. 3A-3E merely illustrate an example of the different states the cheese may go through in particular embodiments of the system and methods described herein. In certain embodiments, the dried cheese crisp may be produced without the cheese going through one or more of the states illustrated. In some embodiments, the cheese may go through additional states during the production of the dried cheese crisp. In some embodiments, one or more non-cheese ingredients may be mixed with the granulated cheese during particular states the cheese goes through during production. In those embodiments, the states illustrated may be the same or modified depending on the one or more non-cheese ingredients that are introduced.

The systems and methods described herein may include one or more technical advantages. For example, embodiments described herein, may allow the use of any type of raw cheese to produce a dried cheese crisp. The raw cheese introduced to the system need not be of a particular type or have a particular formulation. For example, the raw cheese may be a melting cheese. Nor does the raw cheese require a special treatment, such as the application of a particular coating, before being processed to produce the dried cheese crisp. In addition, multiple cheeses at varied amounts (e.g. at different volumes, weights, or percentages) may be mixed together to form a dried cheese crisp with a unique texture, taste, and flavor.

Another technical advantage of the system and method of producing a cheese product is that in certain embodiments, the drying of the cheese requires a single drying process carried out over a short period of time. As discussed above, in particular embodiments, the grinding of the raw cheese into small granules and the drying using at least microwave radiation provides a simple and quick process of producing a dried cheese crisp.

In addition, certain embodiments present the advantage of providing a versatile system to produce a variety of different dried cheese crisp products. In some embodiments, the dryer may comprise different heating elements. The combination of different heating elements may produce a superior product having a better taste, texture, or other quality, or a product that is more uniform crisp to crisp. In addition, some embodiments allow for the cheese to be dried in various sizes, shapes, and thicknesses by dispensing the granulated cheese into different molds and in different volumes. The system and method in particular embodiments allow for different dispensing, drying, and cooling settings and modulation to provide the optimal production of the dried cheese crisp based on the type of cheese introduce among other factors.

Another technical advantage in particular embodiments of the system and method is the ability to produce a dried cheese crisp product with or without certain inclusions. In some embodiments, non-cheese ingredients may be introduced to the granulated cheese before drying. Different included ingredients may change the flavor, texture, nutritional profile, or other characteristics of the final dried cheese crisp. For example, the producer may mix particular herbs and spices into the granulated cheese in order to produce a dried cheese crisp having those introduced flavors which complement the cheese flavor already present.

Although the present disclosure has been described with several embodiments, numerous changes, variations, alterations, transformations, and modifications can be suggested to one skilled in the art, and it is intended that the present disclosure encompass such changes, variations, alterations, transformations, and modifications as fall within the scope of the appended claims.

1. An apparatus for the production of a cheese product, comprising:
a grinder operable to receive raw cheese and grind the cheese into granules having less than 0.25 inches in length;
a dispenser operable to dispense the granulated cheese into one or more receptacles;
a dryer comprising a microwave element, the dryer operable to heat and remove moisture from the granulated cheese using at least microwave radiation in a heating zone;
a cooling tunnel operable to cool and remove moisture from the dried cheese,

2. The apparatus in claim 1, wherein the microwave element emits radiation at a frequency in the range of 850 to 950 MHz in the heating zone.

3. The apparatus of claim 1, wherein the dryer further comprises an oven element operable to expose the granulated cheese to heated air in the heating zone.

4. The apparatus of claim 1, further comprising a mixer operable to mix one or more non-cheese ingredients into the granulated raw cheese before it enters the dryer.

5. The apparatus of claim 4, wherein at least one of the non-cheese ingredients comprises a vegetable, a fruit, a flavor, a spice, an herb, a nut, a vitamin, a mineral, or a functional nutrient.

6. The apparatus of claim 1, wherein the final moisture content of the cheese product is 2.5% or less.

7. The apparatus of claim 1, wherein the dryer comprises a ventilator operable to provide a relative humidity below 50% in the heating zone.

8. The apparatus of claim 1, wherein cooling tunnel comprises a forming element capable of forming the dried cheese into a three dimensional shape.

9. The apparatus of claim 1, wherein the raw cheese comprises one or more of the following types of cheese: Cheddar cheese, Monterey Jack cheese, Gouda cheese, and/or Parmesan cheese.

10. A method for producing a dried cheese crisp, comprising:
grinding raw cheese into granules, each granule of raw cheese having a length less than 0.25 inches;
dispensing a portion of the granulated raw cheese into one or more receptacles;
drying the granulated raw cheese comprising exposing the granulated raw cheese to microwave radiation; and
cooling the dried cheese to create the dried cheese crisp.

11. The method of claim 10, further comprising mixing one or more non-cheese ingredients into the granulated raw cheese prior to drying.

12. The method of claim 11, wherein at least one of the non-cheese ingredients comprises a vegetable, a fruit, a flavor, a spice, an herb, a nut, a vitamin, a mineral, or a functional nutrient.

13. The method of claim 10, wherein the microwave radiation has a frequency in the range of 850 to 950 MHz.

14. The method of claim 10, wherein the power of the microwave radiation is determined depending on the composition and volume of the dispensed granulated cheese.

15. The method of claim 10, wherein drying further comprises exposing the granulated raw cheese to hot air with a temperature of at least 350 F.

16. The method of claim 10, wherein cooling comprises:
removing the dried cheese from the one or more receptacles; and
forming the dried cheese into a three-dimensional shape by bending, folding, or molding the dried cheese.

17. The method of claim 10, further comprising continuously unloading the dried cheese crisp from a cooling tunnel onto a conveyor belt.

18. The method of claim 10, wherein, the drying is performed at a relative humidity of less than 50%.

19. The method of claim 10, wherein the drying comprises exposing the granulated raw cheese to a first power level of microwave radiation followed by exposing the granulated raw cheese to a second power level of microwave radiation, wherein the first power level is higher than the second power level.

20. A method for producing dried cheese crisps, comprising:
providing raw cheese;
cutting the raw cheese into smaller pieces of raw cheese;
grinding the smaller pieces of raw cheese into granules, each granule of raw cheese having a length less than 0.25 inches;
dispensing a quantity of granulated cheese into one or more receptacles;
drying the dispensed granulated cheese in a microwave cavity;
removing excess moisture from the microwave cavity to provide a relative humidity of less than 50%; and
cooling the dried cheese comprising removing surface moisture to produce the dried cheese crisp.
